(19) United States
(12) Patent Application Publication
(10) Pub. No.: US 2008/0015807 A1
(43) Pub. Date: Jan. 17, 2008

(54) TRANSFERRING DATA IN A PORTABLE ELECTRONIC DEVICE

(75) Inventor: Wan Ki HONG, Suwon-si (KR)

Correspondence Address: FISH & RICHARDSON P.C., P.O. BOX 1022, MINNEAPOLIS, MN, 55440-1022, US

(73) Assignee: LG ELECTRONICS INC., Seoul (KR)

(21) Appl. No.: 11/673,011

(22) Filed: Feb. 9, 2007

(30) Foreign Application Priority Data
Jul. 11, 2006 (KR) 10-2006-0064932

(51) Int. Cl. G01C 25/00

(52) U.S. Cl. 702/116

(57) ABSTRACT

An apparatus and a method of receiving/transmitting data in an electronic device are provided. A remaining capacity of a battery mounted to the electronic device is checked. When the remaining capacity of the battery is smaller than a predetermined reference value, a communication module takes over a control with regard to data reception/transmission. Also, power supply to the communication module and a memory unit is maintained, while power supply to the rest of components of the electronic device including a central processing unit is cut off. Accordingly, data can be received/transmitted as much as possible, and reception/transmission of data which has not been completely received/transmitted can be automatically performed when power is recovered.

### BACKGROUND

1. Technical Field

This disclosure relates to transferring data in a portable electronic device.

2. Description of the Related Art

In general, a portable electronic device employs a rechargeable battery. The battery is used for only a limited period of time according to the amount of power consumed by the portable electronic device and a capacity of the battery. For this reason, a user of the portable electronic device must periodically check a remaining capacity of the battery so as to determine when to replace or recharge the battery.

In some cases, the user operates the portable electronic device with a battery having a low remaining capacity. For example, when the user is downloading particular contents to the portable electronic device from another device connected to the portable electronic device by wire or wirelessly, the user desires to continue to operate the portable electronic device until all of the data files constituting the corresponding contents are received.

In such a case, if the data files are being downloaded in a state where the battery has a low capacity, the power of the portable electronic device may be abruptly turned off in the middle of the data file reception when the battery power is completely exhausted.

Then, the user must replace or recharge the battery, or supply power to the portable electronic device through an AC power adaptor, so that the portable electronic device is rebooted, and the data files are downloaded again.

However, it is very inconvenient for the user to re-download the data files since the user must re-access the device having the corresponding data files, and re-download the data files from the beginning. Furthermore, if the power is re-supplied to the portable electronic device after a substantial amount of time, to receive the data files that have not yet been received, the user who does not remember all the data files of the corresponding contents must find a storage path of the corresponding data files, and then download the corresponding data files from the first.

### SUMMARY

In one general aspect, an electronic device for data transfer comprises a communication unit, a memory unit and a central processing unit configured to control the communication unit and the memory unit. The memory unit is configured to store data which was received through the communication unit or which is to be transmitted through the communication unit. The electronic device is configured to switch between a normal mode and a power emergency management mode based on a status of a power source for the electronic device and whether the electronic device is transferring data. For example, the power source may be a battery and the electronic device may operate in the power emergency management mode when a remaining capacity of the battery is lower than a predetermined value.

In another general aspect, an electronic device and a method of transferring data allow only minimum functions necessary for data transfer to be performed through power management, so that data desired by a user can be transferred as much as possible when battery power gets nearly exhausted during the data transfer.

In another general aspect, an electronic device and a method for receiving/transmitting data allow only minimum functions necessary for data reception/transmission to be performed through power management, so that data desired by a user can be received/transmitted as much as possible when battery power gets nearly exhausted during the data reception/transmission using the portable electronic device, and also allow storage of information on data which is not completely received/transmitted because of a completely exhausted battery, so that the reception/transmission of the data which have not been completely received/transmitted is automatically completed when the power of the battery is recovered.

In another general aspect, an apparatus that receives/transmits data in a portable electronic device includes a battery capacity detecting unit that detects a remaining capacity of a mounted battery, and a central processing unit that performs control to switch an operation mode into a power emergency management mode, so that power is supplied only to a communication module and a memory unit related to data reception/transmission when the remaining capacity of the battery detected by the battery capacity detecting unit is smaller than a predetermined reference value. A communication module takes over a control with regard to data reception/transmission processing from the central processing unit, and performs the data reception/transmission with an external device in the power emergency management mode. A memory unit stores data received by the communication module.

In another general aspect, a method of receiving/transmitting data in a portable electronic device includes: checking a remaining capacity of a battery mounted to the portable electronic device; determining whether data reception/transmission is performed when the remaining capacity of the battery is smaller than a predetermined reference value; granting a control with regard to data reception/transmission to a communication module, and maintaining power supply to the communication module and a memory unit while cutting off power supply to the rest of components of the portable electronic device including a central processing unit, when the data reception/transmission is performed; and performing emergency data reception/transmission under control of the communication module.

In another general aspect, when a battery power becomes insufficient during data reception/transmission of a portable electronic device driven by the battery power, the portable electronic device is controlled to perform only minimum functions necessary for the data reception/transmission. Accordingly, data can be received as much as possible using the remaining battery capacity. Also, when the power is re-supplied to the portable electronic device after being turned off because of the complete exhaustion of the battery, the portable electronic device re-accesses a source device that stores the remaining corresponding data. Thus, a user does not have to search for the corresponding data twice.

It is to be understood that both the foregoing general description and the following detailed description are exemplary and explanatory and are intended to provide further explanation of the subject matter claimed.

Additional features will be apparent from the description which follows, including the drawings, and the claims.

### BRIEF DESCRIPTION OF THE DRAWINGS

FIG. 1 is a block diagram illustrating an electronic device.

FIG. 2 is a flowchart for a method of data transfer.

FIG. 3 is a graph showing one example of a battery discharge characteristic curve which may be used to detect a remaining capacity of a battery power of an electronic device.

FIG. 4 is a flowchart for a method of data transfer after re-supply of power.

FIG. 5 is a flowchart for a method of receiving data in a notebook computer.

### DETAILED DESCRIPTION

An electronic device which is driven by a battery power is controlled to perform only minimum functions necessary for data reception/transmission when the battery power becomes insufficient during the data reception/transmission. Also, the electronic device may store information on data that has not been completely received/transmitted because of the completely exhausted battery power, and may automatically perform reception/transmission of the corresponding data when power is re-supplied to the electronic device.

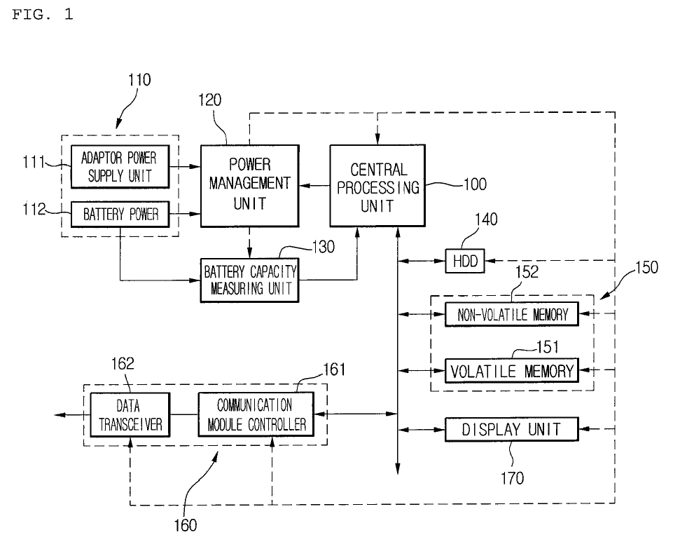

FIG. 1 is a block diagram of an electronic device that includes a central processing unit 100, a power supply unit 110, a power management unit 120, a battery capacity detecting unit 130, a hard disc drive (HDD) 140, a memory unit 150, a communication module 160, and a display unit 170. The electronic device may be, for example, a portable electronic device.

The power supply unit 110 supplies operating power of the electronic device, and includes an adaptor power supply unit 111 that supplies power provided from an AC power adaptor, and a battery power 112 which may be a rechargeable battery.

The power management unit 120 supplies or cuts off power supplied from the power supply unit 110 to each of the components of the portable electronic device, under control of the central processing unit 100.

When the battery power 112 of the power supply unit 110 supplies operating power of the portable electronic device, the battery capacity detecting unit 130 detects a remaining capacity of the battery power 112, and outputs information on the detected remaining capacity to the central processing unit 100.

The HDD 140 is a component that stores an operation program for the electronic device, other application programs, and large digital contents desired by a user.

The memory unit 150 is an information storage device that provides high-rate data processing. The memory unit 150 includes a volatile memory 151 which stores information only when power is supplied, and a non-volatile memory 152 which retains stored information even when the power supply is cut off. The non-volatile memory 152 may include a flash memory or a read-only memory (ROM) storing a system program or the like.

The flash memory in the non-volatile memory block 152 may be configured as a separate memory, or may be implemented by adding a flash memory area to the HDD 140 or forming a memory slot at the HDD 140. The flash memory may be turned OFF when the electronic device is in a normal operation mode, and turned ON only when the electronic device is in an S3 mode (power saving mode) and an S4 mode (maximum power saving mode).

The S3 mode is a stand-by state, in which power supply to most of system components is reduced or cut off while the memory is activated.

The S4 mode (maximum power saving mode) is a sleep state, in which the system power is removed to reduce power consumption of the system to a minimum level after data is stored in the HDD. When the power is later recovered to a regular level, the stored memory contents are recovered, and thus the operational state when the maximum power-saving mode was started is restored.

The communication module 160 is a component such as a network card that communicates with an external device for data exchange between the external device and the electronic device. The communication module 160 includes a communication module controller 161 which performs interface and communication protocol processing with the external device under control of the central processing unit 100, and a data transceiver 162 which performs data reception/transmission with the external device under control of the communication module controller 161.

In a power emergency management mode, the communication module controller 161 takes over a control with regard to communication with the external device from the central processing unit 100. Thus, after the central processing unit 100 is turned OFF, the communication module controller 161 controls data reception/transmission with the external device before the complete exhaustion of the battery power.

The display unit 170 may include an image processing circuit and a liquid crystal display device (LCD), and display an image signal processed by the image processing circuit on the LCD.

The central processing unit 100 controls each of the components of the portable electronic device system. During a power emergency management mode, the central processing unit 100 applies a control signal to the power management unit 120 to supply power only to components related to the data reception/transmission.

An operation of the data receiving/transmitting of the portable electronic device, and an emergency data receiving/transmitting method in a battery power shortage state are described in detail below.

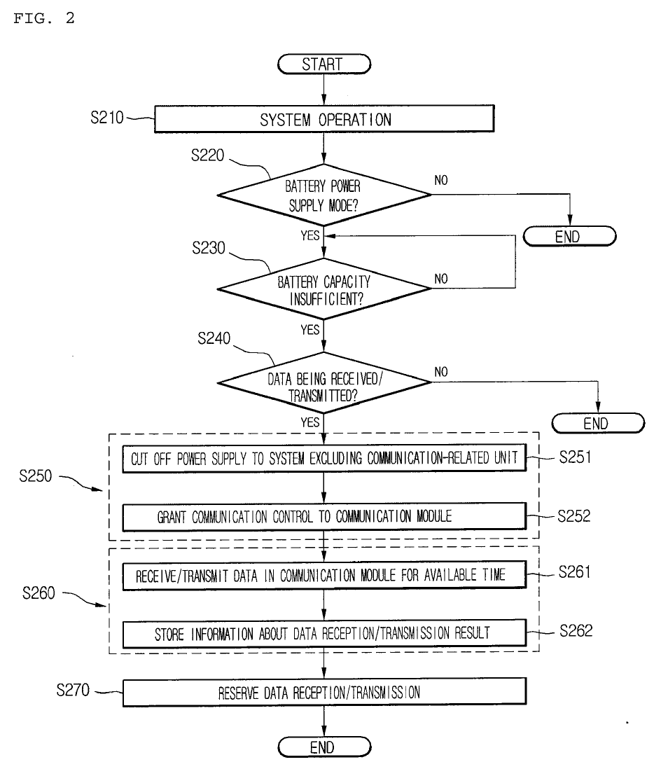

FIG. 2 is a flowchart of a data receiving/transmitting method in an electronic device.

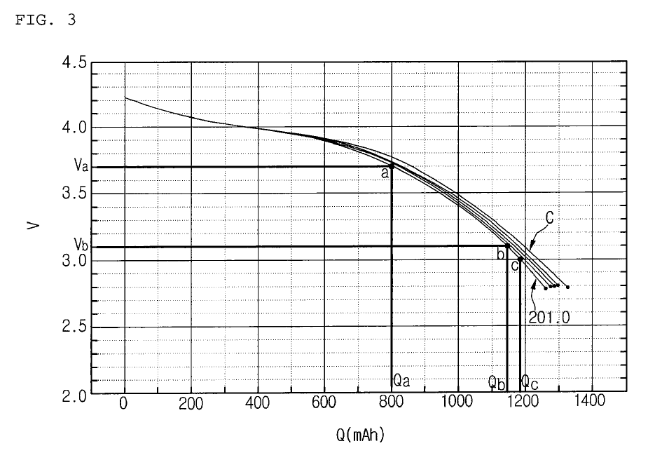

FIG. 3 is a graph showing example curves of a battery discharge characteristic used to detect a remaining capacity of a battery.

Referring to FIGS. 1 and 2, when the power supply unit 110 supplies power to the portable electronic device at step S210, a system program and an operation program stored in, for example, a ROM of the non-volatile memory 152 are booted. Then, the operation of the portable electronic device is started under control of the central processing unit 100 according to a set operation environment.

The power management unit 120 supplies or cuts off power being supplied from the power supply unit 100 to the battery capacity detecting unit 130, the hard disc drive (HDD) 140, the memory unit 150, the communication module 160, and the display unit 170 under control of the central processing unit 100.

When an external AC adaptor supplies power to the portable electronic device through the adaptor power supply unit 111, power shortage does not occur. Thus, the maximum data receiving/transmitting method performed when the power shortage occurs in the portable electronic device is performed only in the case where the power supply unit 110 supplies power through the battery power 112, as illustrated by step S220.

When the battery power supplies power to the portable electronic device, the battery capacity detecting unit 130 detects a remaining capacity of the mounted battery.

To detect the remaining capacity of the mounted battery, battery characteristic values are detected, such as a current value output from the battery and a voltage value detected at both ends of the battery. Then, the detected battery characteristic values are compared to battery discharge curve data as shown in FIG. 3, thereby calculating the remaining capacity of the battery. In this manner, the accurate remaining capacity corresponding to a power consumption rate in a current operational state of the electronic device can be obtained.

For example, the current battery capacity is 800 mAh (Q_{\textcircled{a}} value) corresponding to spot \textcircled{a} of the discharge curve 201.0, when the lowermost battery discharge curve 201.0 among several discharge curves showing discharge characteristics of the mounted battery is a discharge curve of the current power consumption state, and V_{\textcircled{a}} is a voltage value at both ends of the battery. Accordingly, if the mounted battery may be effectively used up to 3.0 V, the current battery capacity is calculated by subtracting the value of Q_{\textcircled{a}} from a value of Q_{\textcircled{c}}.

After the current battery capacity is obtained, for example, through the aforementioned process, the central processing unit 100 can calculate a battery available time, which is the time for the battery to get completely exhausted from the current operational state.

The battery capacity detecting unit 130 outputs the detected remaining-capacity data of the battery to the central processing unit 100. After receiving the detected remaining-capacity data of the battery output from the battery capacity detecting unit 130, the central processing unit 100 determines whether the remaining capacity of the battery is smaller than a predetermined reference value and thus the portable electronic device is in a battery power shortage state at step S230.

The battery power shortage state may refer to a situation where the detected remaining-capacity of the battery is smaller than the predetermined reference power value. The battery power shortage state may also be explained in the context of remaining time. That is, the detected remaining-capacity of the battery may also be viewed as an available time of the battery (i.e., a period of time for which the battery is available). Thus, the battery power shortage state may refer to the situation where the available time of the battery matches a predetermined reference time period.

For example, on the assumption that the portable electronic device is continuously operated in a current operational environment, when the battery available time is one minute, which is a predetermined reference time period, it is determined as the battery power shortage state. The reference time period may be set otherwise based on various circumstances.

When it is determined that the battery power is insufficient (i.e., battery power shortage state) as a result of the determination at step S230, the central processing unit 100 determines whether or not the communication module 160 is receiving/transmitting data, at step state S240.

When it is determined that the communication module 160 is currently not in the data reception/transmission state, the central processing unit 100 may output a message about the battery power shortage state to a user through the display unit 170 or a sound output unit (not shown), so that the user can take appropriate actions. Also, the central processing unit 100 may convert a mode of the device into the S3 mode during the battery available time to turn OFF a peripheral device, so that the battery consumption is maintained to the minimum extent and then the portable electronic device system is terminated when the battery gets completely exhausted.

However, based on the determination at step S240, when the communication module 160 is receiving a content file from an external device or transmitting data stored in the electronic device to an external device, the central processing unit 100 converts an operation of the portable electronic device into a power emergency management mode so that data being received/transmitted can be received/transmitted as much as possible, or contents desired by the user can be primarily received/transmitted during the battery power shortage state as illustrated by step S250 in FIG. 2.

In the power emergency management mode, the battery power is supplied only to a minimum number of components of the portable electronic device, which are directly related to the data reception/transmission, so that power consumption of the portable electronic device is minimized, and thus the data being received/transmitted can be received/transmitted to the maximum extent.

Specifically, in the power emergency management mode, power is supplied only to the communication module 160 performing communication with the external device, and the memory unit 150 storing data received/transmitted by the communication module 160.

In such a case, since power being supplied to the central processing unit 100 is also cut off, the central processing unit 100 grants a control regarding communication with the external device to the communication module 160. Accordingly, communication for data exchange with the external device is performed by the communication module controller 161 of the communication module 160 as illustrated by step S252.

To this end, the central processing unit 100 notifies the communication module controller 161 of information about the battery available time calculated on the basis of the battery remaining capacity detected by the battery capacity detecting unit 130.

Also, the central processing unit 100 may estimate a current communication state and the size of a content data file to be received/transmitted. Based on that, the central processing unit may notify the user and the communication module 160 of the size of data that can be received/transmitted, and simultaneously store information on contents that cannot be received/transmitted within the available time in the non-volatile memory 152 or the HDD 140.

When the communication module 160 receives information on the battery available time and takes over the control with regard to the communication from the central processing unit 100, the communication module controller 161 of the communication module 160 continuously performs emergency data reception/transmission, and stores information on the result of the data reception/transmission at step S260.

In more detail, the communication module controller 161 maintains communication with the external device so that the current data reception/transmission can be continuously performed during the available time as illustrated by step S261.

When a plurality of content data files are to be received, the communication module 160 notifies the external device, for example, a base station, of battery capacity shortage and content priorities to receive only content data files of higher priorities, and then closes the communication. Then, when power is re-supplied, the communication module 160 controls a data reception/transmission process so as to receive only the portion of the content data files that have not been received.

Information on the data reception/transmission performed during the battery available time is stored in the non-volatile memory 152, so that the information on the reception/transmission of the corresponding data can be retained even though the battery power gets completely exhausted and the portable electronic device is turned off at step S262.

Here, when the emergency data reception/transmission performed in the power emergency management mode by the portable electronic device is data reception from a specific source device, the data that has been received until the battery available time is also stored in the non-volatile memory.

The information on the data reception/transmission may further include file information of data being received/transmitted, information on whether reception/transmission of a corresponding file is completed, configuration information of an entire data package, which is needed when there is data which is not completely received/transmitted until the battery available time, and number information of a data packet that is completely received/transmitted until the battery available time.

In the case where the data reception/transmission is not completed even by the emergency data reception/transmission at step S260, automatic reception/transmission of data which has not been completely received/transmitted is reserved, so that the corresponding data can be automatically received/transmitted when the power is re-supplied and the portable electronic device re-accesses the network at step S270.

Regarding the reserving of the data reception/transmission, in the case where the uncompleted data reception/transmission is data reception, the communication module 160 transmits an identification (ID) of the portable electronic device and final data reception state information to a source device that is transmitting the data. Accordingly, when power is re-supplied to the electronic device, the portable electronic device automatically re-accesses the source device, and the rest of the corresponding data that has not been received is completely received at the portable electronic device.

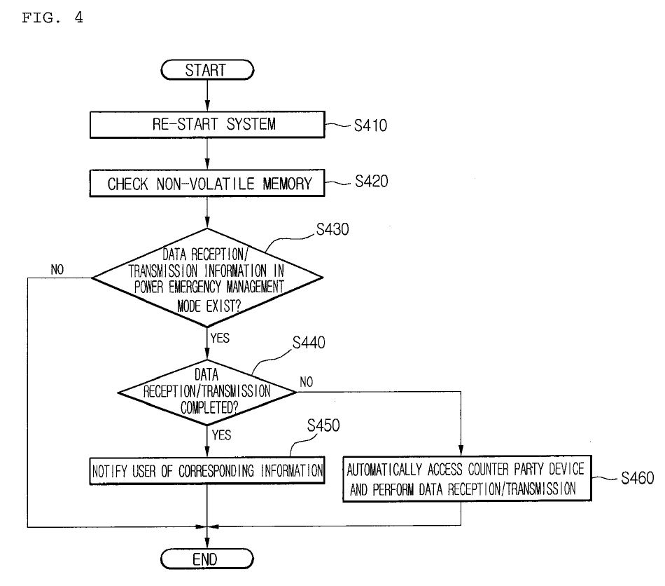

When the uncompleted automatic data reception/transmission is data transmission, the communication module 160 stores an ID of a counter party device (i.e., external device) that is receiving data, final data transmission state information, and path information of a corresponding file in the non-volatile memory 152. Thus, when power is re-supplied, the uncompleted data transmission is automatically performed. FIG. 4 is a flowchart of an automatic data reception/transmission process for automatically receiving/transmitting data which has not been completely received/transmitted, after re-supply of power. When an external AC adaptor power supplies power through the adaptor power supply unit 111 or a recharged battery is mounted to supply power to the portable electronic device and a power switch is turned on, the power management unit 120 supplies power to the portable electronic device system including the central processing unit 100 and the communication module 160, thereby re-starting the operation of the system at step S410.

As the portable electronic device system starts operation, the central processing unit 100 examines the non-volatile memory 152 at step S420.

Then, at step S430, it is determined whether information on data reception/transmission, which was performed in the power emergency management mode prior to the re-start of the system by control of the communication module 160, is stored.

When the information on the data reception/transmission performed in the power emergency management mode is stored, it is determined whether the reception/transmission of corresponding data has been completed, at step S440.

When it is determined that the reception/transmission of the corresponding data has been completed S440, the reception/transmission result of the corresponding data is output to a user at step S450. Particularly, when the completed reception/transmission is data reception, the data received and stored in the non-volatile memory 152 is copied and stored in an assigned space of a storage medium such as the HDD 140.

When it is determined that the reception/transmission of the corresponding data is not completed at step S440, the portable electronic device accesses a counterpart device, with which the electronic device was communicating during the prior emergency power management mode, and automatically performs the automatic data reception/transmission process for automatically receiving/transmitting data which has not been completely received/transmitted, at step S460.

Here, in the case where a process performed in the power emergency management mode is data transmission, to automatically transmit data that has not been completely transmitted, the central processing unit 100 of the portable electronic device reads information on the corresponding-data transmission state and information on the counterpart device, which are stored in the non-volatile memory 152, and performs automatic access to the counterpart device.

When the automatic access to the counterpart device is made, the portable electronic device confirms to the counterpart device whether to perform reserved data transmission. When the portable electronic device receives a request for data transmission from the counterpart device, the reserved data transmission is performed.

Also, when a process performed in the power emergency management mode is data reception, to automatically receive data which has not been completely received, the central processing unit 100 of the portable electronic device reads information on the corresponding data reception state and information on a source device, which is stored in the non-volatile memory 152, and tries automatic access to the source device.

When the automatic access to the source device is made, the portable electronic device makes a request for the reserved data reception from the source device, and receives and stores the corresponding data transmitted from the source device. Accordingly, the portable electronic device completely receives the rest of data that was not received because of the battery power shortage.

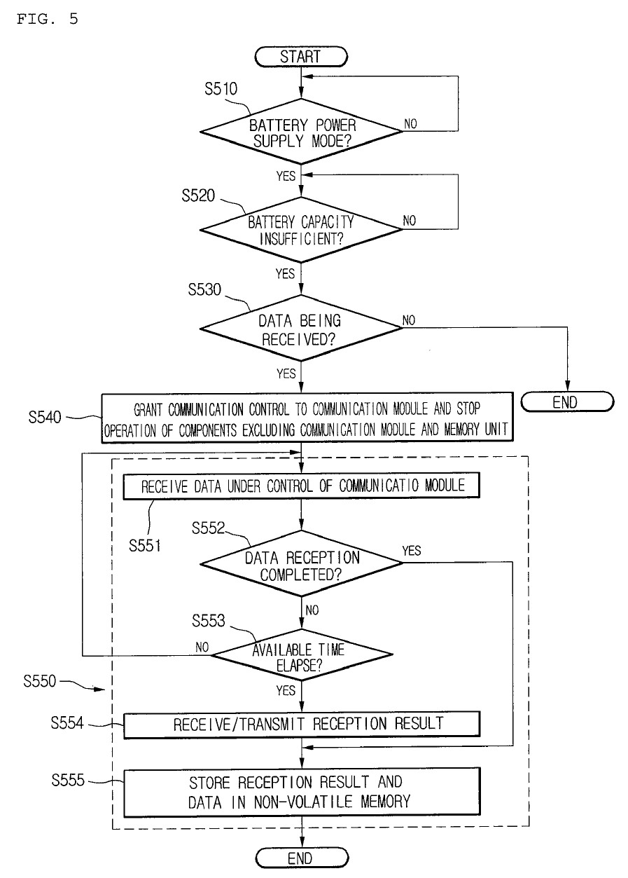

One particular situation where a battery power gets almost exhausted while a notebook computer is receiving predetermined contents from an external device through a radio base station is described below. FIG. 5 is a flowchart for a content receiving method.

Referring to FIGS. 1 and 5, the central processing unit 100 during operation of the notebook computer determines whether power is being supplied from a rechargeable battery at S510.

When it is determined that the power is being supplied from the rechargeable battery, information about a remaining battery capacity detected by the battery capacity detecting unit 130 is received, and, based on that, it is determined whether the remaining battery capacity is smaller than a predetermined reference value at step S520.

When it is determined that the remaining battery capacity is insufficient at step S520 (for example, when a battery available time in the current state is one minute, which is a predetermined reference time), it is determined, at step S530, whether the notebook computer is receiving predetermined contents from an external device via a radio base station.

When it is determined that the notebook computer is not receiving the predetermined contents from an external device, a general power saving mode (S3 or S4) is performed.

### However, when it is determined that the notebook computer is receiving the predetermined contents from an external device, the mode is switched into the power emergency management mode immediately at step S540.

The power emergency management mode is distinguished from the general power saving modes (S3 and S4) in that, during the power emergency management mode, power is supplied only to the elements necessary for data reception/transmission.

### That is, power supply to circuits and peripheral devices of the notebook computer are cut off, except for the communication module 160 and the memory unit 150 that stores received data or the like.

At this time, the power supply even to the central processing unit 100 may be cut off. In this case, before the power supply to the central processing unit 100 is cut off, the central processing unit 100 sends information on the battery available time calculated on the basis of the remaining capacity detected by the battery capacity detecting unit (130), and grants a control with regard to data reception from the external device to the communication module 160.

Accordingly, the communication module 160, which now has the control with regard to the data reception from the external device, maintains communication with the external device, performs data reception for the available time, and stores reception result information at step S550.

In more detail, the communication module 160, which now has the control with regard to the data reception from the external device, performs data reception for the available time while maintaining communication with the external device at step S551.

While performing the data reception from the external device, the communication module 160 determines whether the reception of the desired data is completed at step S552.

When it is determined that the data reception is completed, information about completion of the data reception, and the received data are stored in the non-volatile memory S555.

However, when it is determined that the data reception is not completed, it is determined whether the available time elapses at step S553.

When it is determined that the available time does not elapse S553, the communication module 160 continues to perform the data reception. However, when the available time elapses, the communication module 160 terminates reception of data being received via the base station, sends the current battery capacity information and the result of the data reception made until the available time elapses to the counter part device via the base station, and closes communication at step S554. Then, the data reception result and the received data are stored in the non-volatile memory 152 such as a flash memory at step S555. Alternatively, instead of storing the received data in the non-volatile memory 152 at step S555, data being received may be intermittently stored in the non-volatile memory 152 during the power emergency management mode

Thereafter, when power is re-supplied to the notebook computer as a battery is replaced or power is recovered, the discontinued data reception may be automatically resumed based on the data reception result stored at step S555.

The automatic receiving of the data which has not been completely received may be performed under control of the central processing unit 100 as a power switch of the notebook computer is switched on and the system properly operates.

Alternatively, even if the user does not turn on the power of the notebook computer after the power recovery, the communication module 160 checks the power state when the power is recovered, and then automatically accesses the external device via the base station to notify the external device of data reception result information including the size of the received data. In such a manner, the remaining data, which has not yet been received may be completely received. In this case, when the reception is completed, power supply to the communication module 160 may be cut off.

In the case where the power switch is switched on and thus the central processing unit 100 controls the overall system, the central processing unit 100 may notify a user of a result of data reception performed in the prior power emergency management mode, which is stored in the non-volatile memory 152, through the display unit 170 and a sound output unit.

According to the electronic device and method for transferring data as described above, when the battery power becomes insufficient while data desired by a user is being received/transmitted, the data can be received/transmitted as much as possible through power management that allows only minimum functions necessary for the data reception/transmission to be performed.

Also, when the battery power becomes insufficient during data reception/transmission, information about data that has not been completely received/transmitted is stored, so that the discontinued data reception/transmission can be automatically completed when the power is recovered. Thus, even when the data reception/transmission is discontinued because of the battery power shortage, the user does not have to make additional efforts to complete the unfinished data reception/transmission.

Other implementations are within the scope of the following claims.

What is claimed is:

1. An electronic device for data transfer, the device comprising:
a communication unit;
a memory unit configured to store data which was received through the communication unit or which is to be transmitted through the communication unit; and
a central processing unit configured to control the communication unit and the memory unit, wherein the electronic device is configured to operate in a power emergency management mode based on a status of a power source for the electronic device and whether the electronic device is transferring data.

2. The electronic device of claim 1, wherein the power source is a battery and the electronic device operates in the power emergency management mode when a remaining capacity of the battery is lower than a predetermined value.

3. The electronic device of claim 1, wherein the central processing unit is turned off during the power emergency management mode.

4. The electronic device of claim 1, wherein information related to a status of the data transfer is stored in the memory unit during the power emergency management mode.

5. The electronic device of claim 4, wherein the electronic device resumes data transfer in a normal mode, based on the information stored during the power emergency management mode.

6. The electronic device of claim 4, wherein the information stored during the power emergency management mode includes an identity of a device communicating with the electronic device.

7. An apparatus of transferring data, the apparatus comprising:
a battery capacity detecting unit configured to detect a remaining capacity of a battery;
a central processing unit;
a communication module; and
a memory unit configured to store data received by or to be transmitted by the communication module,
wherein the central processing unit is configured to control switching an operation mode into a power emergency management mode when the remaining capacity of the battery detected by the battery capacity detecting unit is smaller than a predetermined reference value.

8. The apparatus of claim 7, wherein the communication module is configured to take over a control with regard to data transfer processing from the central processing unit and perform data transfer with an external device in the power emergency management mode.

9. The apparatus of claim 7, wherein power is supplied only to the communication module and the memory unit in the power emergency management mode.

10. The apparatus according to claim _, wherein the memory unit comprises a non-volatile memory and a volatile memory.

11. The apparatus according to claim 8, wherein the communication module comprises:
a communication module controller configured to take over the control with regard to the data transfer from the central processing unit; and
a data transceiver for transferring data under control of the communication module controller.

12. A method of transferring data in an electronic device, the method comprising:
checking a remaining capacity of a battery mounted to the electronic device;
determining whether data is being transferred when the remaining capacity of the battery is smaller than a predetermined reference value; and
granting a control regarding the data transfer to a communication module, when the data transfer is being performed.

13. The method according to claim 12, further comprising maintaining power supply to the communication module and a memory unit in the electronic device while cutting off power supply to other components of the electronic device.

14. The method according to claim 12, wherein the granting of the control comprises notifying the communication module of information about a battery available time.

15. The method according to claim 12, further comprising:
performing the data transfer until a battery available time elapses; and
storing information about the data transfer performed until the battery available time elapses in a non-volatile memory.

16. The method according to claim 12, further comprising, when power is re-supplied to the electronic device, resuming the data transfer to transfer data which has not been completely transferred during a prior operation.

17. The method according to claim 16, further comprising transmitting an identification of the electronic device and information about a final data reception state to a source device.

18. The method according to claim 16, further comprising storing an identification of a counterpart device, information about a final data transmission state, and information about a path of a corresponding file in a non-volatile memory.

19. The method according to claim 16, wherein the resuming of the data transfer comprises:
trying automatic access to a counterpart device;
receiving a request for data transmission from the counterpart device; and
transmitting the data which has not been completely transferred during the prior operation to the counterpart device.

20. The method according to claim 16, wherein the resuming of the data transfer comprises:
trying an automatic access to a source device;
making a request for data reception from the source device; and
receiving the data which has not been completely transferred during the prior operation from the source device.
